(19) United States
(12) Patent Application Publication
(10) Pub. No.: US 2010/0251815 A1
(43) Pub. Date: Oct. 7, 2010

(54) THERMAL FLOW SENSOR WITH TURBULENCE INDUCERS

(75) Inventors: Frank Schnur, Boenningheim (DE); Helmut Schneider-Koenig, Remshalden (DE)

Correspondence Address: The Ollila Law Group LLC, 2569 Park Lane, SUITE 202, Lafayette, CO, 80026, US

(73) Assignee: Norgren GmbH, Alpen (DE)

(21) Appl. No.: 12/746,840

(22) PCT Filed: Dec. 21, 2007
(86) PCT No.: PCT/EP07/64467

§ 371 Date: Jun. 8, 2010

(51) Int. Cl. G01F 1/68

(52) U.S. Cl. 73/204.11

(57) ABSTRACT

A flow sensor (100) is disclosed provided with a body (102) with a first opening (128) and a second opening (130) and a flow pathway (103) coupling the first opening (128) to the second opening (130). At least one thermal sensor (140) is located in the flow pathway (103) between the first opening (128) and the second opening (130). A first turbulence inducer (114, 116, or 118) is located between the first opening (128) and the at least one thermal sensor (140). The turbulence inducer consists of a mesh of joined beams that define a plurality of voids.

### BACKGROUND OF THE INVENTION

Thermal mass flow sensors measure the flow of material by measuring the amount of heat energy transferred by the flowing material. Thermal mass flow sensors typically come in one or two wire designs, but both designs operate on the same principle of measuring the amount of heat energy transferred by the flowing fluid. In a one wire design a single heating element is placed in the fluid flow. The flow of fluid transfers heat away from the heating element. A regulator keeps the heating element at a constant temperature. The heating element's power consumption used to maintain the constant temperature is a measure of the mass flow of the fluid. For accurate measurements the heating element should be placed where the flow of fluid is smooth. Current flow sensors may require turbulence pacifiers comprising tube lengths up to 10 times the tube diameter to establish smooth flow. This increases the overall length of the flow sensor.

### SUMMARY OF THE INVENTION

The scope of the present invention is defined solely by the appended claims, and is not affected to any degree by the statements within this summary.

In one embodiment of the present invention, a flow sensor comprises a body provided with a first opening and a second opening with a flow pathway coupling the first opening to the second opening, at least one thermal sensor located in the flow pathway between the first opening and the second opening, and a first turbulence inducer located between the first opening and the at least one thermal sensor.

In another embodiment of the present invention, a method of operating a flow sensor comprises the steps of introducing a flow of fluid into the flow sensor from a first direction, creating turbulence in the fluid flowing in the first direction, and measuring a flow rate in the fluid flowing in the first direction using a sensor where the sensor is located in the fluid flowing in the first direction after the turbulence has been created.

In yet another embodiment of the present invention, a flow sensor comprises a body provided with a first opening and a second opening with a fluid passageway coupling the first opening to the second opening, at least one thermal sensor located in the fluid passageway between the first opening and the second opening, and a means for inducing turbulence into a fluid flowing from the first opening to the at least one thermal sensor.

### ASPECTS

According to one aspect of the present invention, a flow sensor includes a body provided with a first opening and a second opening with a flow pathway coupling the first opening to the second opening, at least one thermal sensor located in the flow pathway between the first opening and the second opening, and a first turbulence inducer located between the first opening and the at least one thermal sensor.

Preferably, the first opening and the second opening have a first cross sectional area and the flow pathway has a second cross sectional area and where the first cross sectional area is smaller than the second cross sectional area.

Preferably, the first turbulence inducer is a mesh of joined beams provided with a generally rectangular cross sectional shape.

Preferably, the first turbulence inducer is formed with a plurality of beams that define a plurality of voids wherein the voids are provided with shapes that are generally square, generally triangular, generally rectangular, generally hexagonal, or generally parallelograms.

Preferably, a second turbulence inducer is located between the second opening (130) and the at least one thermal sensor.

Preferably, the second turbulence inducer is a mesh of joined beams provided with a generally rectangular cross sectional shape.

Preferably, a second turbulence inducer and a third turbulence inducer are located between the first turbulence inducer and the thermal sensor.

Preferably, there is an un-equal space between the first, second, and third turbulence inducers.

Preferably, there is an equal space between the first, second and third turbulence inducers.

Preferably, a space between the first and second turbulence inducers is selected from the group: 5 mm, 10 mm, 15 mm, 20 mm, 25 mm.

Preferably, the first, second and third turbulence inducers have a mesh pattern and the mesh pattern of at least one of the first, second and third turbulence inducers is oriented to be at an angle relative to the mesh pattern of at least one other turbulence inducer.

Preferably, the angle is 120 degrees.

According to another aspect of the present invention, a method of operating a flow sensor includes the steps of introducing a flow of fluid into the flow sensor from a first direction, creating turbulence in the fluid flowing in the first direction, and measuring a flow rate in the fluid flowing in the first direction using a sensor where the sensor is located in the fluid flowing in the first direction after the turbulence has been created.

Preferably, the method includes the steps of introducing a flow of fluid into the flow sensor from a second direction, creating turbulence in the fluid flowing in the second direction, and measuring a flow rate in the fluid flowing in the second direction using the sensor where the sensor is located in the fluid flowing in the second direction after the turbulence has been created.

Preferably, the turbulence is created using a plurality of turbulence inducers.

Preferably, the plurality of turbulence inducers are evenly spaced along a flow path.

Preferably, the plurality of turbulence inducers have a mesh pattern and the mesh pattern of at least two turbulence inducers are oriented to be at an angle with respect to each other.

Preferably, the plurality of turbulence inducers are formed from a mesh of joined beams where the beams have a generally rectangular cross sectional shape.

According to yet another aspect of the present invention, a flow sensor includes a body provided with a first opening and a second opening with a fluid passageway coupling the first opening to the second opening, at least one thermal sensor located in the fluid passageway between the first opening and the second opening, and a means for inducing turbulence into a fluid flowing from the first opening to the at least one thermal sensor.

### BRIEF DESCRIPTION OF THE DRAWINGS

The present invention will now be described, by way of example only, with reference to the accompanying drawings in which:

FIG. 1 is a sectional view of flow sensor in an example embodiment of the invention.

FIG. 2A is an isometric front view of body in an example embodiment of the invention.

FIG. 2B is an isometric top view of body in an example embodiment of the invention.

FIG. 3A is an isometric view of one of the turbulence inducer assemblies in an example embodiment of the invention.

FIG. 3B is an isometric view of mount in an example embodiment of the invention.

FIG. 3C is a front view of turbulence inducer in an example embodiment of the invention.

FIG. 3D is an isometric view of washer in an example embodiment of the invention.

FIG. 3E is an exploded view of a plurality of turbulence inducer assemblies oriented at an angle relative to each other.

FIG. 4 is an isometric side view of thermal sensor assembly in an example embodiment of the invention.

FIG. 5A depicts a parallelogram shaped void defined by a turbulence inducer of an embodiment of the present invention.

FIG. 5B depicts a rectangular shaped void defined by a turbulence inducer of an embodiment of the present invention.

FIG. 5C depicts a triangular shaped void defined by a turbulence inducer of an embodiment of the present invention.

FIG. 5D depicts a hexagonal shaped void defined by a turbulence inducer of an embodiment of the present invention.

FIG. 5E depicts a parallelogram shaped void defined by a turbulence inducer of an embodiment of the present invention.

FIG. 6A depicts a rectangular shaped beam of an embodiment of the present invention.

FIG. 6B depicts a square shaped beam of an embodiment of the present invention.

FIG. 6C depicts a triangular shaped beam of an embodiment of the present invention.

FIG. 6D depicts a cylindrical shaped beam of an embodiment of the present invention.

FIG. 6E depicts an ovular shaped beam of an embodiment of the present invention.

FIG. 6F depicts a parallelogram shaped beam of an embodiment of the present invention.

FIG. 6G depicts a parallelogram shaped beam of an embodiment of the present invention.

FIG. 6H depicts a hexagonal shaped beam of an embodiment of the present invention.

FIG. 6I depicts a T shaped beam of an embodiment of the present invention.

FIG. 7 is a cross sectional view of the fluid flow as it passes by the turbulence inducer in an example embodiment of the invention.

FIG. 8A is a flow diagram showing the flow of fluid through a pipe without any turbulence inducers.

FIG. 8B is a flow diagram showing the flow of fluid through a pipe with three turbulence inducers spaced along the length of the flow pathway in an example embodiment of the invention.

### DETAILED DESCRIPTION OF THE PRESENTLY PREFERRED EMBODIMENTS

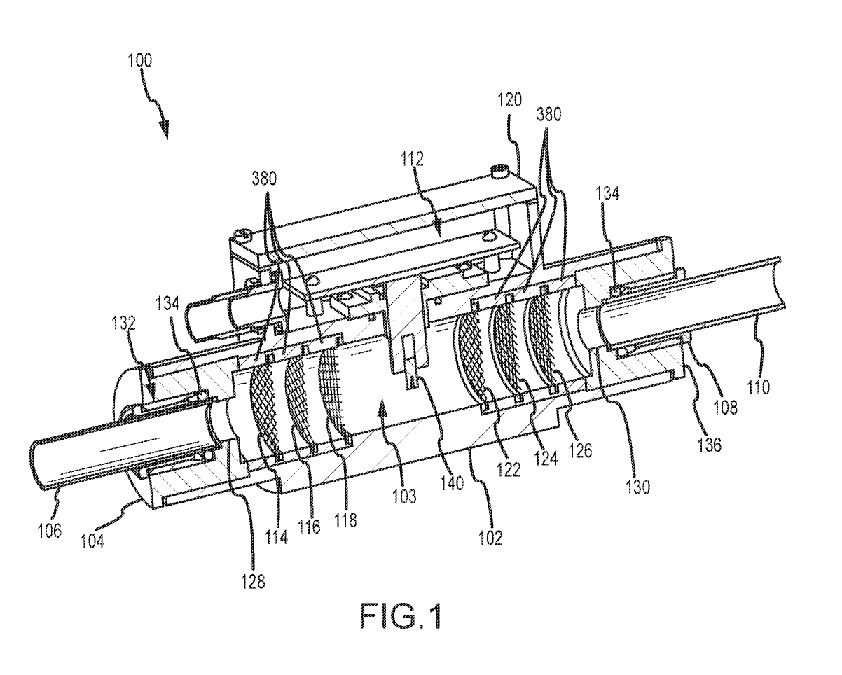

FIGS. 1-8B and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is a sectional view of flow sensor 100 in an example embodiment of the invention. Flow sensor 100 comprises body 102, turbulence inducer assemblies 114, 116, 118, 122, 124 and 126, electronics assembly 112, lid 120, pipe mounting plugs 104 and 136, O-rings 134, and pipe fittings 132 and 108. Body 102 has a tube shaped passageway running along the length of body 102 and an electronics compartment formed on the top of the preferably generally tube shaped flow pathway 103. Installed in one end of the flow pathway 103 are a first set of three turbulence inducer assemblies 114, 116 and 118. Installed in the other end of the flow pathway 103 are a second set of three turbulence inducer assemblies 122, 124 and 126. Electronics assembly 112 is installed into the electronics compartment on the top side of body 102 and has thermal sensor 140 extending preferably into the middle of the flow pathway 103 between the two sets of turbulence inducers. Lid 120 is mounted on top of the electronics compartment and seals the electronic assembly 112 into the electronic compartment. Pipe mounting plug 104 is installed into one end of the flow pathway 103 formed in body 102 and holds turbulence inducer assemblies 114, 116 and 118 in place inside the flow pathway 103. Pipe mounting plug 136 is installed into the other end of the flow pathway 103 formed in body 102 and holds turbulence inducer assemblies 122, 124 and 126 in place inside the flow pathway 103. Pipe 106 is installed into pipe mounting plug 104 and held in place by pipe fixture 132. Pipe 110 is installed into pipe mounting plug 136 and held in place by pipe fixture 108. O-rings 134 help form seals between the pipes 106 and 110 and the pipe mounting plugs 104 and 136. Pipe mounting plugs 104 and 136 have opening 128 and 130 respectively that are the same diameter as the inner diameters of pipes 106 and 110.

In operation, fluid flowing in pipe 106 enters flow sensor 100 through opening 128 in pipe mounting plug 104. The flowing fluid then strikes and passes through the first set of three turbulence inducing assemblies 114, 116 and 118. The turbulence inducers create turbulence in the flowing fluid. The flow of fluid then passes by thermal sensor 140 that is immersed in the flow path of the fluid. The three turbulence inducing assemblies 114, 116 and 118 function to create a smooth flow of fluid as it passes by the immersed thermal sensor 140. The flowing fluid then passes through the second set of three turbulence inducer assemblies 122, 124 and 126 and exits the flow sensor through opening 130 and enters pipe 110.

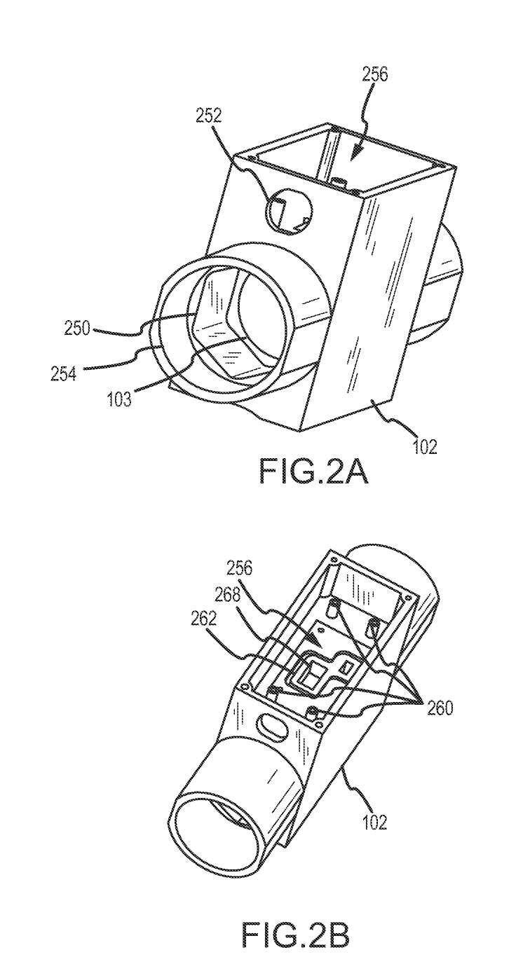

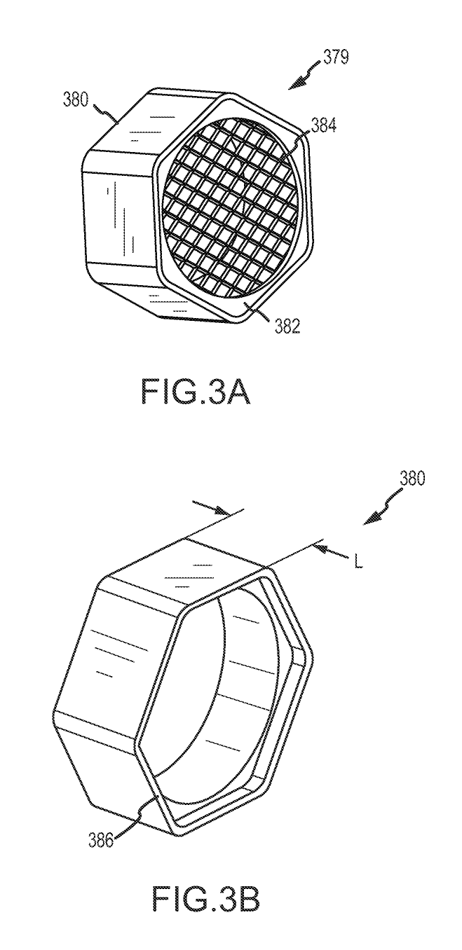

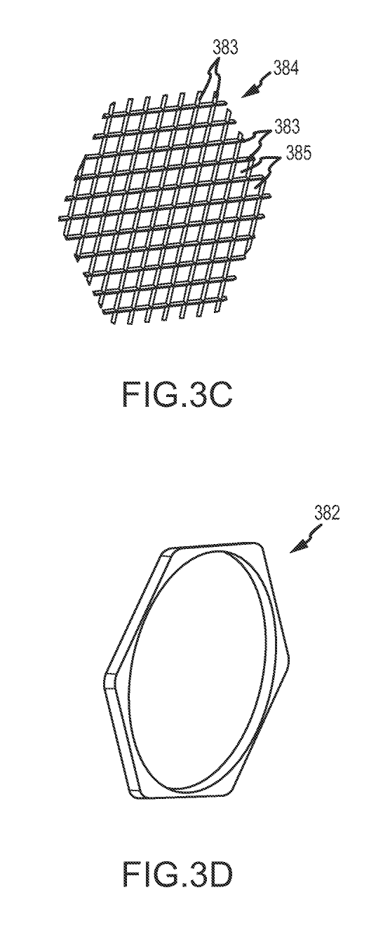

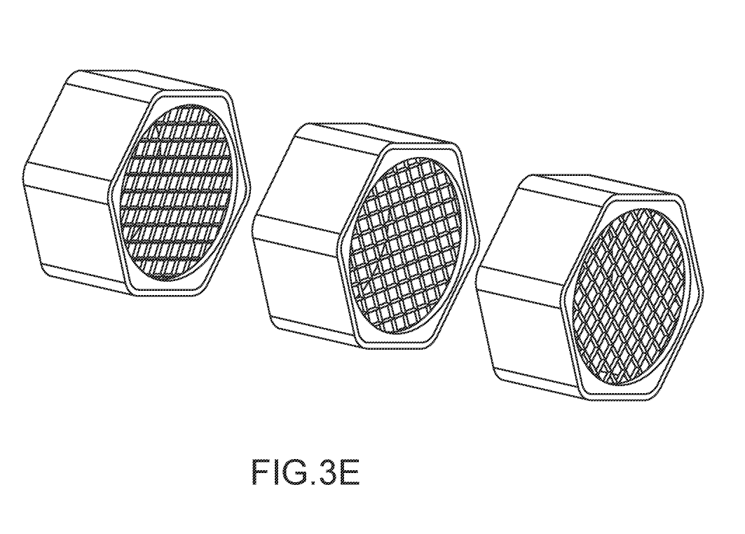

FIG. 2A is an isometric front view of body 102 in an example embodiment of the invention. Body 102 has a preferably generally tube shaped or cylindrical flow pathway 103 formed internally inside body 102. An alignment feature 250 is preferably formed at each end of the flow pathway 103 and used to align the turbulence inducer assemblies. In one example embodiment of the invention the alignment feature is a six sided opening that allows a turbulence inducer assembly to be installed in three different orientations. As shown in FIG. 3E, each turbulence inducer 384 is provided with the same mesh pattern and the mesh pattern of each turbulence inducer 384 is oriented 120 degrees with respect to the mesh pattern of one or more adjacent turbulence inducers 384. Those of ordinary skill in the art will appreciate that it is within the scope of the present invention to utilize angles other than 120 degrees may be used. An opening 254 for the pipe mounting plug is formed into each end of the body 102 at the end of the two alignment feature 250. Opening 252 is formed into the electronics compartment 256 and used to mount an output port for the electronic assembly.

FIG. 2B is an isometric top view of body 102 in an example embodiment of the invention. Openings 268 formed in the bottom of electronics compartment 256 allow the thermal sensors to be inserted into the fluid flowing through the flow pathway 103 in body 102. Mounting studs 260 are used to mount electronics assembly 112 into electronics compartment 256. A sealing groove 262 is formed into the bottom of electronics compartment 256. A gasket installed into sealing groove 262 is used to help form a seal between electronics assembly 112 and the flow pathway 103.

FIG. 3A is an isometric view of one of the turbulence inducer assemblies 379 in an example embodiment of the invention. Each turbulence inducer assembly 379 preferably comprises a mount 380, a turbulence inducer 384 and a washer 382. FIG. 3B is an isometric view of mount 380 in an example embodiment of the invention. Mount 380 has a cylindrical inner bore and a generally six sided outer surface. The six side outer surface is configured to mate with the alignment feature 250 formed in body 102. Mount 380 has length L configured to space the turbulence inducers apart when the three turbulence inducer assemblies are stacked into alignment feature 250. In one example embodiment of the invention each turbulence inducer assembly uses a mount 380 with the same length L to create an even spacing between turbulence inducers 384. In one example embodiment of the invention, length L is set at 10 mm, but may be set at other lengths, for example 5 mm, 20 mm, or the like. Choosing a length L is a trade-off between the overall length of the flow sensor and optimizing the flow profile. In other example embodiments of the invention, mounts having different lengths L may be used for the three turbulence inducer assemblies to create an uneven spacing between the turbulence inducers 384. A channel 386 is formed in the edge of mount 380. FIG. 3C is a front view of turbulence inducer 384 in an example embodiment of the invention. Turbulence inducer 384 is sized to fit into channel 384 formed in mount 380. FIG. 3D is an isometric view of washer 382 in an example embodiment of the invention. Washer 382 is also sized to fit into channel 386 and configured to hold turbulence inducer 384 in place inside channel 386.

Although the present embodiment includes one or more turbulence inducer assemblies 379 provided with a mount 380, a turbulence inducer 384, and a washer 382, it is within the scope of the present invention to utilize other arrangements. By way of example, and not limitation a mount 380 may be provided with two channels 386 located at opposing ends of the mount 380 each for receiving a washer 382 and/or turbulence inducer 384. In alternative embodiments, the washer 382 may be disposed of. In still further embodiments, the mount 380 may be substituted with one or more a spacers (not shown) that are fabricated without a channel 386 and which space the turbulence inducers 384 from each other or position one or more turbulence inducers 384. In yet further embodiments, a mount 380 or spacer may be fabricated integrally with a plug (104) or (136).

Moreover, it is within the scope of the present invention to fabricate the body 102 without the alignment feature 250, to provide the alignment feature 250 with a different shape, and to provide the mount 380 with shapes other than the six-sided outer surface. By way of example, and not limitation, the body 102 may be provided with a generally cylindrical surface that receives the mount and the mount 250 may be provided with a generally cylindrical outer surface. By way of another example, and not limitation, the outer surface of the mount 250 may be provided with one or more raised surfaces that fit into one or more grooves formed in the inner diameter of the opening of the body 102.

FIG. 4 is an isometric side view of thermal sensor assembly 490 in an example embodiment of the invention. Thermal sensor assembly 490 is part of electronics assembly 112 and mounts on the bottom surface of electronics compartment 256 formed in body 102. In one example embodiment of the invention thermal sensor assembly 490 has two thermal sensors 140 extending downward and configured to fit through the openings 268 in the bottom of electronics compartment 256 and into the flow of fluid in the flow pathway 103. In other example embodiments of the invention only one thermal sensor may extend down into the fluid flow.

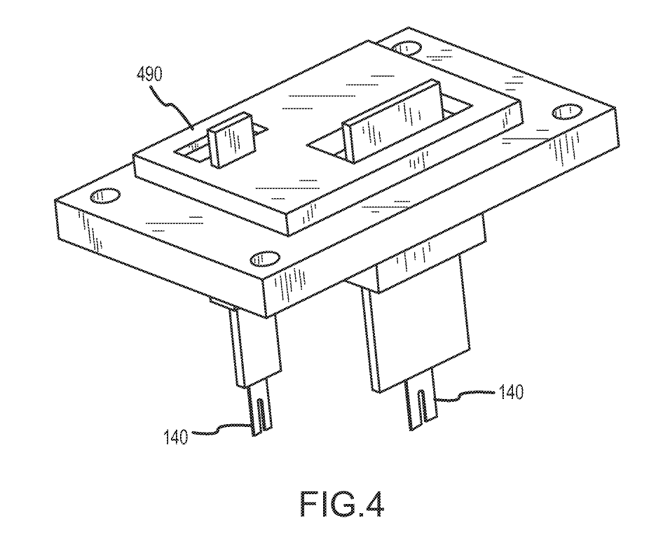

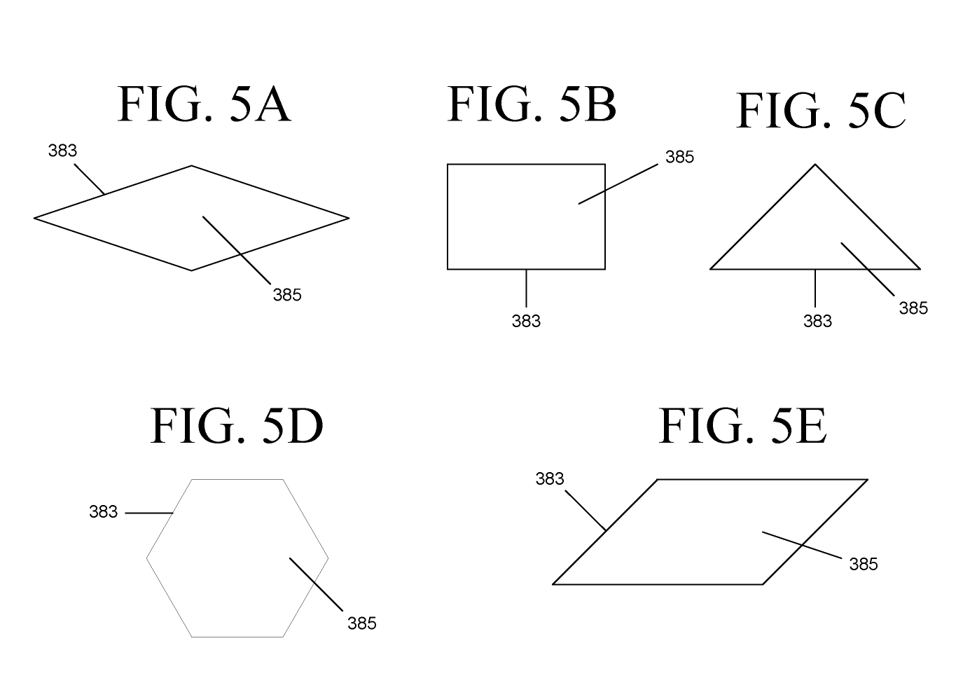

As shown in FIG. 3C, the turbulence inducer 384 is comprised of joined beams 383 that define a mesh pattern of voids 385. In the embodiment shown in FIG. 3C, the turbulence inducer 384 is in a plane that is cut into a six sided piece that fits into mount 380. In the embodiment shown in FIG. 3C, the voids 385 are preferably provided with a generally square shape; however, as shown in FIG. 5A-5C, it is within the scope of the present invention to provide the voids 385 with other shapes. For example, and not limitation, the voids 385 may be provided with shapes that are generally a parallelogram, generally rectangular, generally triangular, generally hexagonal, or other otherwise generally non-square.

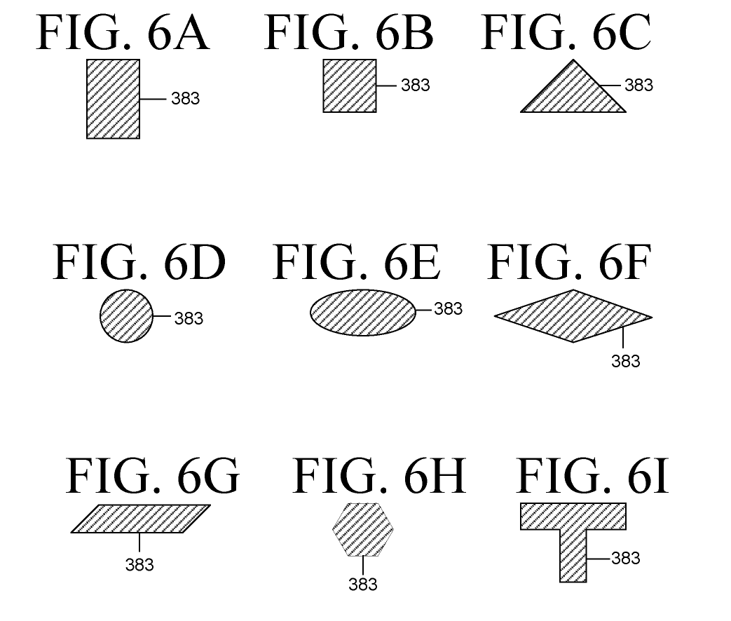

In the embodiment shown in FIG. 3C, the beams 385 are preferably provided with a rectangular shape, as shown in FIG. 6A. In alternative embodiments, however, as shown in FIGS. 6B-6I, the beams 385 may be provided with other shapes, such as for example, and not limitation, a shape that is generally square, generally triangular, generally cylindrical, generally ovular, generally a parallelogram, generally hexagonal, generally T-shaped, or that is otherwise generally non-rectangular.

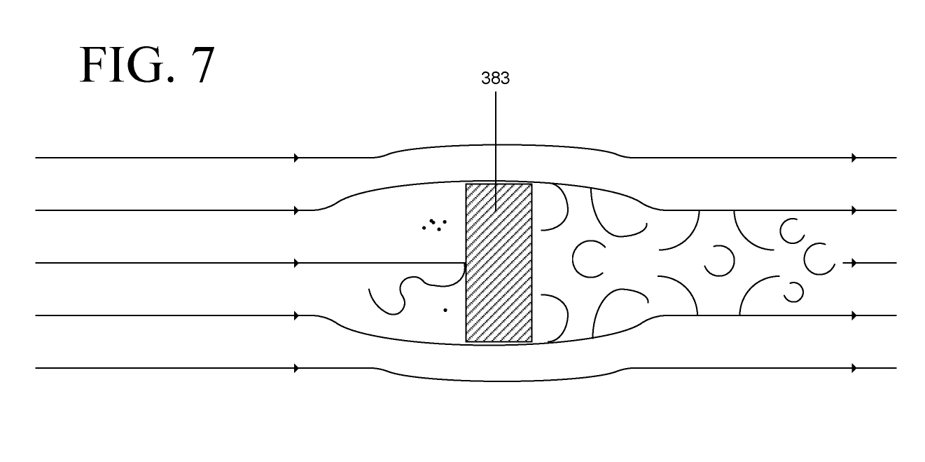

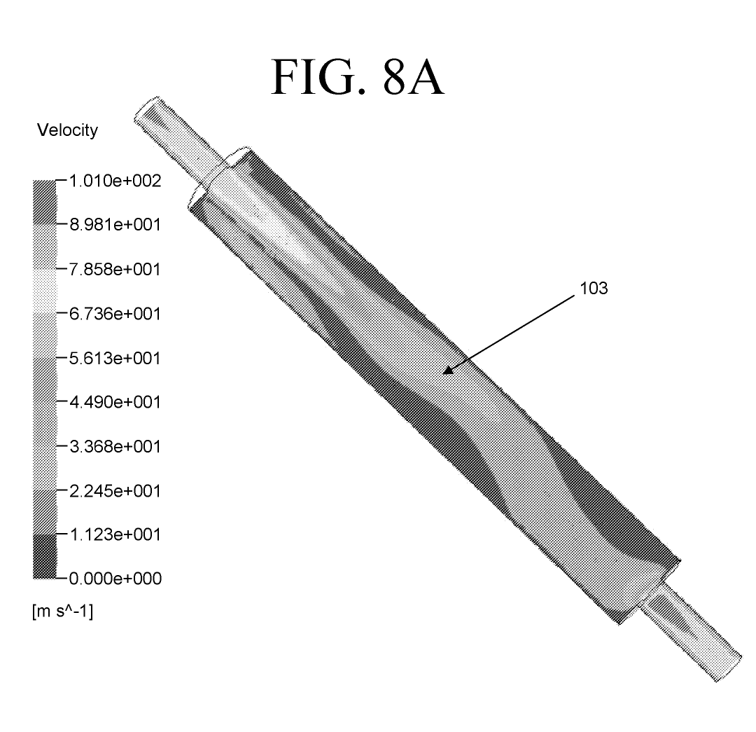

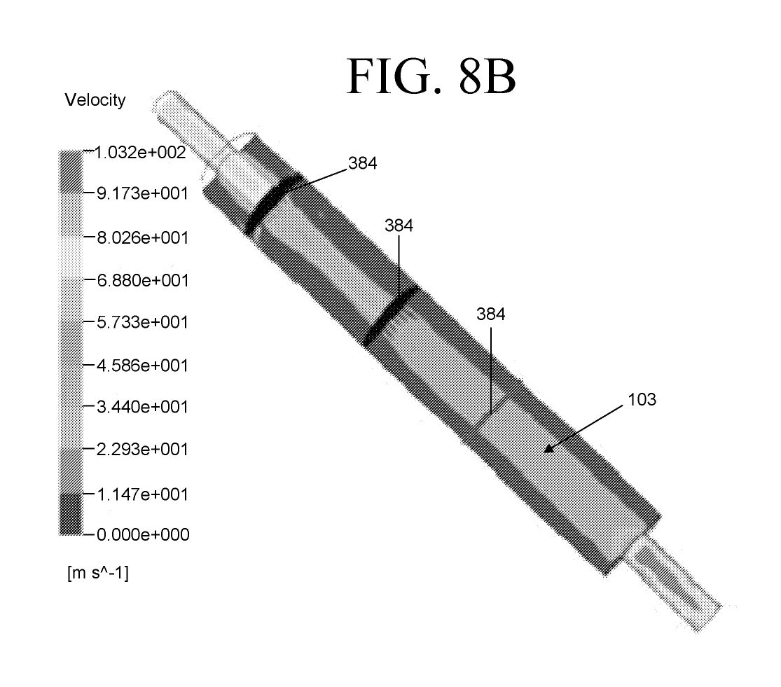

FIG. 7 is a cross sectional view of the fluid flow as it passes by the turbulence inducer in an example embodiment of the invention. As shown, therein as the fluid flows past the beam 386 and through the voids 385, eddy currents are generated. Advantageously, the generation of the eddy currents causes the fluid to travel at a more uniform velocity through the flow pathway 103 of the body 102. FIG. 8A is a flow diagram showing the flow of fluid through a pipe without any turbulence inducers. As can be seen, the flow path 103 of the fluid is still meandering and has a widely varying velocity profile near the end of the tube. FIG. 8B is a flow diagram showing the flow of fluid through a pipe with three turbulence inducers spaced along the length of the tube in an example embodiment of the invention. The flow pathway 103 of the fluid after the third turbulence inducer is smoothly flowing with an evenly distributed velocity profile. Even after passing just the first turbulence inducer, the flow pathway 103 is improved compared with the flow path shown in FIG. 8A. Turbulence inducer 384 may be fabricated as a sieve formed from a stamped sheet of metal, as a molded piece of plastic, a woven wire mesh, or the like.

Flow sensor 100 is shown with two sets of turbulence inducer assemblies, one set on either side of thermal sensor 120, allowing flow sensor 100 to be used as a bi-directional flow meter with a flow of fluid entering the flow sensor through either pipe 106 or pipe 110. In other example embodiments of the invention, flow sensor 100 may have only one set of turbulence inducer assemblies on one side of thermal sensor 120, creating a flow sensor limited to measuring flow in only one direction.

In one example embodiment of the invention, flow sensor 100 is shown with a set of three turbulence inducers placed in the flow before the flow reached the thermal sensor 140. The number of turbulence inducers, the spacing between the turbulence inducers, the orientation between the turbulence inducers and the cross sectional profile of the turbulence inducers are variables that can be used in a trade-off between the overall length of the flow sensor 100, the smoothness of the flow at the thermal sensor and the cost of manufacturing flow sensor 100. In one example embodiment of the invention, for a low cost flow sensor 100, only one turbulence inducer is placed in the flow before the thermal sensor and the turbulence inducer is fabricated from a wire screen or mesh.

We claim:

1. A flow sensor (100), comprising:
a body (102) provided with a first opening (128) and a second opening (130) with a flow pathway (103) coupling the first opening to the second opening,
at least one thermal sensor (140) located in the flow pathway (103) between the first opening (128) and the second opening (130); and
a first turbulence inducer (114) located between the first opening (128) and the at least one thermal sensor (140).

2. The flow sensor (100) of claim 1 where the first opening (128) and the second opening (130) have a first cross sectional area and the flow pathway (103) has a second cross sectional area and where the first cross sectional area is smaller than the second cross sectional area.

3. The flow sensor (100) of claim 1 where the first turbulence inducer (114) is a mesh of joined beams (383) provided with a generally rectangular cross sectional shape.

4. The flow sensor (100) of claim 1 where the first turbulence inducer (114) is formed with a plurality of beams (383) that define a plurality of voids (385) wherein the voids (385) are provided with shapes that are generally square, generally triangular, generally rectangular, generally hexagonal, or generally parallelograms.

5. The flow sensor (100) of claim 1 further comprising:
a second turbulence (122) inducer located between the second opening (130) and the at least one thermal sensor (140).

6. The flow sensor (100) of claim 5 where the second turbulence inducer (122) is a mesh of joined beams (383) provided with a generally rectangular cross sectional shape.

7. The flow sensor (100) of claim 1 further comprising:
a second turbulence inducer (116) and a third turbulence inducer (118) where the second and third turbulence inducers (116, 118) are located between the first turbulence inducer (114) and the thermal sensor (140).

8. The flow sensor (100) of claim 7 where there is an un-equal space between the first, second, and third turbulence inducers (114, 116, 118).

9. The flow sensor (100) of claim 7 where there is an equal space between the first, second and third turbulence inducers (114, 116, 118).

10. The flow sensor of claim 7 where a space between the first and second turbulence inducers (114, 116) is selected from the group: 5 mm, 10 mm, 15 mm, 20 mm, 25 mm.

11. The flow sensor (100) of claim 7 where the first, second and third turbulence inducers (114, 116, 118) have a mesh pattern and the mesh pattern of at least one of the first, second and third turbulence inducers (114, 116, 118) is oriented to be at an angle relative to the mesh pattern of at least one other turbulence inducer (114, 116, 118).

12. The flow sensor (100) of claim 11 where the angle is 120 degrees.

13. A method of operating a flow sensor (100), comprising:
introducing a flow of fluid into the flow sensor (100) from a first direction;
creating turbulence in the fluid flowing in the first direction; and
measuring a flow rate in the fluid flowing in the first direction using a sensor (140) where the sensor (140) is located in the fluid flowing in the first direction after the turbulence has been created.

14. The method of operating a flow sensor (100) of claim 13, further comprising:
introducing a flow of fluid into the flow sensor (100) from a second direction;
creating turbulence in the fluid flowing in the second direction; and
measuring a flow rate in the fluid flowing in the second direction using the sensor (140) where the sensor (140) is located in the fluid flowing in the second direction after the turbulence has been created.

15. The method of operating a flow sensor (100) of claim 13 where the turbulence is created using a plurality of turbulence inducers (114, 116, 118, 122, 124, or 126).

16. The method of operating a flow sensor (100) of claim 15 where the plurality of turbulence inducers (114, 116, 118, 122, 124, or 126) are evenly spaced along a flow path (103).

17. The method of operating a flow sensor (100) of claim 15 where the plurality of turbulence inducers (114, 116, 118, 122, 124, or 126) have a mesh pattern and the mesh pattern of at least two turbulence inducers (114, 116, 118, 122, 124, or 126) are oriented to be at an angle with respect to each other.

18. The method of operating a flow sensor (100) of claim 15 where each of the plurality of turbulence inducers (114, 116, 118, 122, 124, or 126) are formed from a mesh of joined beams (383) where the beams (383) have a generally rectangular cross sectional shape.

19. A flow sensor (100), comprising:
a body (102) provided with a first opening (128) and a second opening (130) with a fluid passageway (103) coupling the first opening (128) to the second opening (130),
at least one thermal sensor (140) located in the fluid passageway (103) between the first opening (128) and the second opening (130); and
a means (114, 116, or 118) for inducing turbulence into a fluid flowing from the first opening (128) to the at least one thermal sensor (140).
